(19) United States
(12) Patent Application Publication
(10) Pub. No.: US 2026/0211741 A1
(43) Pub. Date: Jul. 23, 2026

(54) DATA INGEST TASK ASSIGNMENT

(71) Applicant: VAST DATA LTD., Tel Aviv (IL)

(72) Inventor: Ilan Ben-Hagai, Tel Aviv (IL)

(73) Assignee: VAST DATA LTD., Tel Aviv (IL)

(21) Appl. No.: 19/031,925

(22) Filed: Jan. 18, 2025

(51) Int. Cl. G06F 9/50

(52) U.S. Cl. CPC G06F 9/505

(57) ABSTRACT

A method for managing load regarding to access requests, the method includes (a) receiving an access request by a given compute core of multiple compute cores of a computer node of a group of computer nodes of a storage system; (b) determining, by the given compute core, a destination compute core of the multiple compute cores to respond to the access request based on foreground workload scores and overall workload scores associated with the multiple compute cores; wherein the determining comprises accessing the foreground workload scores and overall workload scores associated with the multiple compute cores; (c) redirecting the access request to the destination compute core when the destination compute core differs from the given compute core; and (d) responding to the access request by the destination compute core, wherein the responding comprise accessing one or more storage nodes of the storage system and outputting an access response.

### BACKGROUND

Workload in a storage system can be changed dynamically, causing bottlenecks and uneven load distribution in multi-processor integrated circuits of the storage system. To eliminate the system's bottlenecks and optimize the resource utilization, there is a demand for employing a workload balancing and adaptive resource management.

Scheduling is the function that is carried out by a scheduler module that executes tasks according to computing resources assigned to the tasks. Scheduling enables multitasking with a single central processing unit (CPU).

The scheduler aims to achieve fairness by assigning computing time to all tasks that are waiting for computing resources, according to priorities and computing workloads on different tasks.

Cooperative multitasking is a multitasking scheduling in which the running tasks voluntarily yield control periodically, or when idle, or when waiting for resources other than computing resources.

Polling and interrupts are used to handle communication between the CPU and other devices such as IOs and network communication ports in storage systems. Implementing these mechanisms is required to ensure timely responses to events. Polling mode can be useful in systems with high frequency events, such as IO responses from storage devices, where the overhead associated with entering and exiting interrupt handlers uses more CPU resources than simply polling.

There is a need to identify and even anticipate situations and conditions that imply a potential workload imbalance, and to smooth the workload accordingly.

### SUMMARY

There may be provided a method, a system and a non-transitory computer readable medium as illustrated in the application.

### BRIEF DESCRIPTION OF THE DRAWINGS

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings in which:

FIG. 1 is an example of a method; and

FIG. 2 is an example of a storage system.

### DETAILED DESCRIPTION OF THE DRAWINGS

A storage system includes multiple compute entities (also referred to as compute cores), that can communicate with each other and can access a shared memory space that stores information about the current status of each compute core. Each compute core can perform polling tasks, foreground tasks and various background tasks.

The foreground tasks, also referred to as ingest tasks, include handling access requests received from users of the storage system, such as read requests and write requests, that need to be responded or acknowledged to the user as fast as possible. The handling of write requests includes safely storing the data of the write requests in write buffers in a temporary storage space that includes fast memory devices, in a redundant manner (e.g., mirroring or erasure coding), before the write request is acknowledged to the user.

Background tasks include tasks that are different from the ingest tasks and does not need responding to the user, for example: tasks for migrating the data stored in the write buffers to a permanent storage space, wherein the migration includes at least one of the tasks: striping related to erasure coding, data reduction, encryption, etc. The background tasks may further include defragmentation of e.g., RAID (Redundant Array of Independent Disks) stripes, metadata, or any other storage space that requires defragmentation. The background tasks may further include data scrubbing for inspecting data integrity and fixing incorrect data.

Each compute core is coupled, via one or more virtual communication paths (e.g., virtual IP address), to one or more users that send the access requests towards the storage system. The access requests are accumulated in an ingest queue of the compute core and includes user requests waiting to be handled.

Each compute core dequeues the next access request to be handled and decides which compute core of the multiple compute cores will handle the access request. The decision regarding the destination compute core that will handle the access request depends on the workload imposed on each of the compute cores, wherein the workload carried on by a single compute core is composed of both the foreground workload (caused by handling foreground tasks) and the background workload (caused by handling background tasks).

The foreground tasks have the highest priority (or at least higher than the background tasks), since their execution dictates the latency experienced by the users. However, the background tasks should not be starved, so as to avoid bottlenecks of background processes, such as exhaustion of write buffers, if the migration process is not constantly executed. Therefore, a portion of the computing resources are reserved for background execution, in addition to allowing the execution of background tasks when the foreground workload is alleviated.

The foreground workload can be determined by the length of the ingest queues. However, the foreground tasks execution is interfered by the execution of background tasks that occurs in parallel to the execution of foreground tasks. This interference leads to compromising the latency. Therefore, when considering distribution of the workload of the foreground tasks, there is a need to consider the influence of the background tasks on the execution of the foreground tasks.

The extent of the expected background workload is not measurable directly, because there may not be a queue of background tasks to be executed by each compute core, and even if there is such a queue with a measurable length, each background task may consume a different amount of compute resources that cannot be anticipated in advance. For example, even if the address space that needs to be defragmented is evenly divided among the compute cores, where each compute core needs to handle an equal size of address zone, some of the address zones may be more fragmented than others—a condition that cannot be detected prior to starting the defragmentation process. As for a second example, even if all the write buffers that need to be migrated are evenly assigned to the compute cores, some of the write buffers may include content that requires migration tasks that consume more compute resources than content that is currently stored in other write buffers.

Therefore, in order to evaluate the expected influence of the background tasks on the execution of the foreground tasks, the length of the scheduling cycle of each compute core is measured.

Each compute core employs a scheduler module that schedules polling tasks, foreground tasks and the background tasks. The scheduling is performed in cycles. Upon each scheduling cycle, compute resources are allocated to both foreground tasks and background tasks that are waiting for compute resources. Tasks are suspended and enter a waiting mode, when waiting for events that include either reception of network communication messages, storage device responses (when an IO is completed), or waiting for reception of messages from another task. Polling tasks are employed so as to detect occurrence of events that should wake up other (non polling) tasks. The event can be a response from a storage device, an incoming message from a communication port, etc. Part of the scheduling cycle (e.g., the start of the scheduling cycle) is dedicated for executing the polling tasks, however the length of this part is known and/or fixed and not influenced by other workloads.

Each scheduling cycle may start (or end) with executing polling tasks and then continuing to execute foreground tasks waiting for compute resources, and finally executing background tasks waiting for compute resources. When a polling task detects an occurrence of an event, it wakes up the corresponding task that waits for the event, i.e., causing the corresponding task to become a task that waits for compute resources so as to handle operations required in response to the event. When no foreground and no background task is waiting for compute resources, the scheduling cycle includes only execution of polling tasks, and the scheduling cycle is ended right after all the polling tasks are executed, following starting a new scheduling cycle. Therefore, when the system is idle, the compute core will still be fully occupied executing polling tasks only, however, the scheduling cycle length is short (e.g., four microseconds, versus a typical cycle of e.g., hundreds microseconds).

When the system is not idle, the execution cycle is ended when the foreground tasks, that need compute resources, have been executed, and at least part of the background tasks, that need compute resources, have been executed.

It can be determined that the compute core is always fully occupied, either by executing only polling tasks, or by executing, in addition to polling, also foreground and background tasks.

The foreground and background tasks may be implemented and scheduled as Fibers in a Cooperative multitasking environment, or as other execution units in other multitasking environments.

According to the described scheduling mechanism, it can be understood that the length of the scheduling cycle depends on the load imposed by background tasks and the load imposed by foreground tasks. A shorter scheduling cycle, implies less load of foreground and background tasks, even tough the compute core is still fully occupied. Though the polling tasks also contribute to the length of the scheduling cycle, this contribution is fixed, while variants in the lengths of various scheduling cycles are caused by background workload and/or foreground workload.

Suppose two ingest queues of two compute cores have the same length, but one compute core (first compute core) has a longer scheduling cycle comparing to the second compute core—it can be determine that the foreground workload may be the same on both compute cores, but there is more background workload on the second compute core, comparing to the first compute core, and will result in a higher latency of the responses issued by the foreground tasks executed on the second compute core.

According to an embodiment of the invention, each compute core measures its average scheduling cycle as experienced by the foreground tasks. One of the foreground tasks (maybe implemented as a Fiber or Thread) represents all the foreground tasks, by calculating the average scheduling cycle length, where the scheduling cycle length is measured as the time passed between the time the foreground task yields control, i.e., completes the current usage of compute resources and gives up the CPU utilization, until the time it regains compute resources, in the next scheduling cycle.

According to an embodiment, each compute core further scores its scheduling cycle by comparing to the scheduling cycles of other compute cores. If the scheduling cycle of a certain compute core is shorter (by at least a certain amount) than the average of the scheduling cycles of all the compute cores, then the certain compute core increments its scheduling cycle score. If the scheduling cycle of the certain compute core is longer (by at least a certain amount) than the average of the scheduling cycles of all the compute cores, then the certain compute core decrements its scheduling cycle score.

According to an embodiment, the scheduling cycle score of a certain compute core can indicate the number of the access requests that can be redirected from a first compute core to the certain compute core in a single redirection. According to another embodiment, the relation between the scheduling cycle score of the certain compute core and the scheduling cycle score of the first compute core can be used for determining the number of the access requests that can be currently redirected. According to another embodiment, the scheduling cycling score is internal in the sense that it is not accessible to other compute cores and is also different from an overall workload score that is exposed to the other compute codes.

The adjustment of the scheduling cycle of each compute core is performed periodically, every time unit of e.g., one second.

According to embodiments of the invention, when a compute core dequeues an access request from its ingest queue, it selects the destination compute core according to both the length of the ingest queues and the scheduling cycle scores of all the compute cores. If the selected destination is the current compute core, then the compute core executes the foreground task for responding to the dequeued access request. If the selected destination is another compute core, then the access request is redirected to the other compute core, e.g. by queueing the access request on the ingest queue of the other compute core.

The selection of the destination compute core may give a priority to the ingest queue length (or alternatively—to the scheduling cycle score), by giving a higher weight to the ingest queue length. Alternatively, the selection of the destination compute core may give the same priority to both the ingest queue length and the scheduling cycle score. According to another example, the compute core with the shortest ingest queue is selected, and in a case where more than one compute core has the same ingest queue length—the compute core with the best scheduling cycle score among them—is selected.

The destination compute core can be determined according to further parameters, other than the ingest queue's length and the scheduling cycle length. For example, the compute core may prefer redirecting a foreground task to a compute core that resides in the same zone as the potential destination compute core, for example the same NUMA (Non-uniform memory access) node.

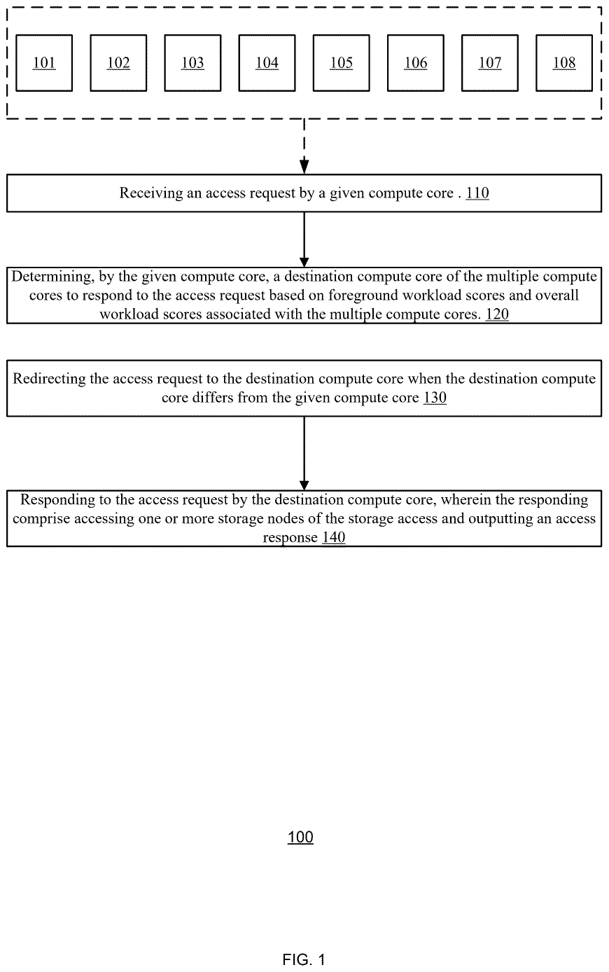

FIG. 1 illustrates method 100 for managing load regarding to access requests. According to an embodiment, method 100 includes step 110 of receiving an access request by a given compute core of multiple compute cores of a computer node of a group of computer nodes of a storage system.

According to an embodiment, step 110 is followed by step 120 of determining, by the given compute core, a destination compute core of the multiple compute cores to respond to the access request based on foreground workload scores and overall workload scores associated with the multiple compute cores. The responding to the access request includes performing one or more foreground tasks related to storing or reading data of the access request. The determination may include the number of access requests that can be redirected, at the time of the determination, from an ingest queue of the given compute core to the destination compute core, based on at least one of: a foreground workload score of the destination compute core, an overall workload score of the destination compute core, a foreground workload score of the given compute core, an overall workload score of the given compute core.

According to an embodiment, step 120 includes accessing the foreground workload scores and overall workload scores associated with the multiple compute cores.

According to an embodiment, for each compute core of the multiple compute cores, the foreground workload score of the compute core is determined by the compute core based on statuses of ingest queues of the compute core, and the overall workload score of the compute core is determined by the compute core based on a measurement, made by the compute core, of a length of a scheduling cycle of the compute core, the scheduling cycle being associated with execution of one or more polling tasks, and one or more additional tasks, wherein each additional task is selected out of a foreground task and a background task;

According to an embodiment, each compute core of the multiple compute cores is configured to (a) determine a foreground workload score of the compute core based on statuses of ingest queues of the compute core, and (b) determine an overall workload score of the compute core based on a measurement, made by the compute core, of a length of a scheduling cycle of the compute core, the scheduling cycle being associated with execution of one or more polling tasks, and one or more additional tasks, wherein each additional task is selected out of a foreground task and a background task. Variants in lengths of scheduling cycles are caused by execution (or lack of execution) of the one or more additional tasks.

According to an embodiment, step 120 is followed by step 130 of redirecting the access request to the destination compute core when the destination compute core differs from the given compute core.

According to an embodiment, step 130 is followed by step 140 of responding to the access request by the destination compute core, wherein the responding comprise accessing one or more storage nodes of the storage access and outputting an access response to a user that sent the access request. The accessing of one or more storage nodes of the storage access and outputting the access response are included in foreground tasks.

According to an embodiment, method 100 includes at least one of:
a. Step 101 of determining, by each compute core of the multiple compute cores, the foreground workload score of the compute core based on the statuses of ingest queues of the compute core. The ingest queues include received access requests. Handling the received access requests includes executing foreground tasks. The statuses of the ingest queues includes, for example, the lengths of the queues.
b. Step 102 of determining, by each compute core of the multiple compute cores, the overall workload score of the compute core based on the measurement, made by the compute core, of the length of the scheduling cycle of the compute core.
c. Step 103 of measuring, by each compute core of the multiple compute cores, the length of the scheduling cycle of the compute core.
d. Step 104 of writing, by each compute core of the multiple compute cores, the foreground workload score and the overall workload score of the compute core to a sharable database. According to an embodiment, the sharable database is stored in a non-volatile memory unit.
e. Step 105 of obtaining, by each compute core of the multiple compute cores, the foreground workload score of the compute core, the foreground workload score is based on the statuses of ingest queues of the compute core.
f. Step 106 of obtaining, by each compute core of the multiple compute cores, the overall workload score of the compute core, the overall workload score is based on the measurement, made by the compute core, of the length of the scheduling cycle of the compute core.
g. Step 107 of obtaining, by each compute core of the multiple compute cores, the length of the scheduling cycle of the compute core.
h. Step 108 of obtaining, by each compute core of the multiple compute cores, the foreground workload score and the overall workload score of the compute core based on information stored in a sharable database. According to an embodiment, the sharable database is stored in a non-volatile memory unit.

According to an embodiment, step 102 includes at least one of:
a. Determining, by a given compute core of the multiple compute cores, an overall workload score of the given compute core regardless of one or more overall workload scores of one or more other compute cores of the multiple compute cores.
b. Determining, by a given compute core of the multiple compute cores, an overall workload score of the given compute core based on one or more workload scores of one or more other compute cores of the multiple compute cores.
c. Determining, by a given compute core of the multiple compute cores, an overall workload score of the given compute core based on statistics of lengths of the scheduling cycle of the compute core during one or more time periods.

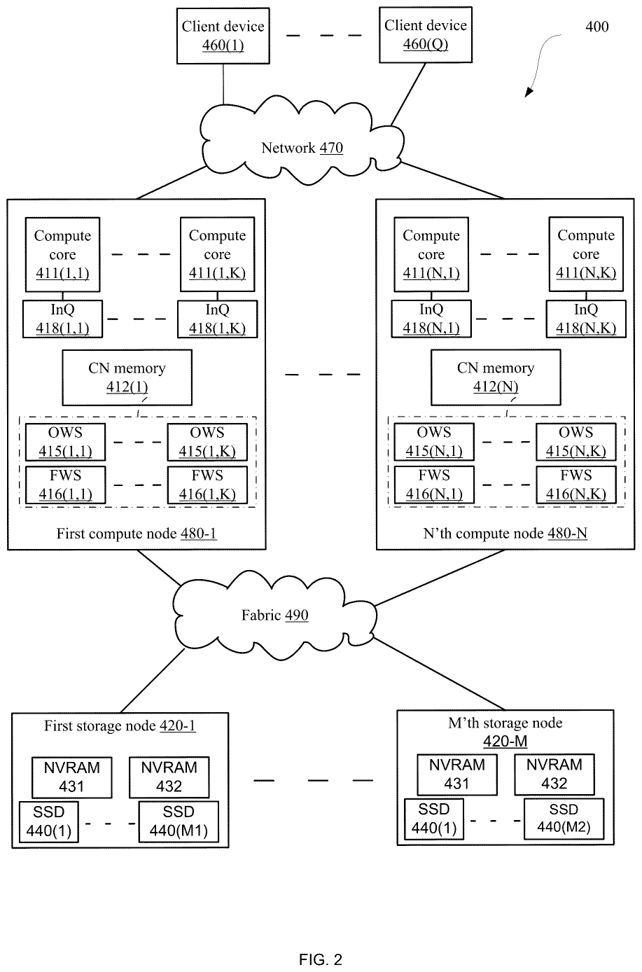

FIG. 2 shows an example diagram of a storage system 400 for managing load regarding to access requests. The storage system 400 includes a number of N compute nodes—from first compute node 480-1 through the N′th compute node 480-N.

Each compute nodes includes multiple compute cores each—see for example compute cores 411(1,1)-411(1,K) of first compute node 480-1 and compute cores 411(N,1)-411(N,K) of N′th compute node 480-N.

First compute node 480-1 also include compute node (CN) memory 412(1) that is illustrated as storing (a) overall workload scores (OWSs) 415(1,1)-415(1,K) of compute cores 411(1,1)-411(1,K), and (b) foreground workload scores (FWSs) 416(1,1)-416(1,K) of compute cores 411(1,1)-411(1,K).

At least a part of the CN memory is a random access memory—being a volatile RAM or a non-volatile RAM.

Each compute nodes include queues—such as ingest queues InQ 418(1,1)-418(1,K) of compute cores 411(1,1)-411(1,K).

According to an embodiment, each compute core is a processing circuit, a part of processing circuit, and the like.

The processing circuit may be implemented as a central processing unit (CPU), a graphic processing circuitry (GPU), and/or one or more other integrated circuits such as application-specific integrated circuits (ASICs), field programmable gate arrays (FPGAs), full-custom integrated circuits, etc., or a combination of such integrated circuits.

Each compute node 480 interfaces with multiple client devices such as a client devices 460(1)-460(Q) (or an application installed therein) via a network 470, for receiving access requests for writing to or reading from the storage system.

The storage system 400 also includes M storage nodes 420-1 through 420-M. The compute nodes and the storage nodes communicate using communication fabric 490. M may equal N or may differ from N.

The storage nodes 420 provide the storage and state in the system 400. Each storage node 420 may include a plurality of SSDs, such as SSDs 440, for example storage node 420-1 includes M1 SSDs 440(1)-440(M1). According to an embodiment, the responding to access requests includes executing foreground tasks that access the storage nodes for reading and writing data of the access requests.

Any reference to “may be” should also refer to “may not be”.

In the foregoing detailed description, numerous specific details are set forth in order to provide a thorough understanding of the one or more embodiments of the disclosure. However, it will be understood by those skilled in the art that the present one or more embodiments of the disclosure may be practiced without these specific details. In other instances, well-known methods, procedures, and components have not been described in detail so as not to obscure the present one or more embodiments of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present one or more embodiments of the disclosure and in order not to obfuscate or distract from the teachings of the present one or more embodiments of the disclosure.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for managing load regarding to access requests, the method comprises:
receiving an access request by a given compute core of multiple compute cores of a computer node of a group of computer nodes of a storage system;
determining, by the given compute core, a destination compute core of the multiple compute cores to respond to the access request based on foreground workload scores and overall workload scores associated with the multiple compute cores;
wherein the determining comprises accessing the foreground workload scores and overall workload scores associated with the multiple compute cores;
wherein for each compute core of the multiple compute cores, the foreground workload score of the compute core is determined by the compute core based on statuses of ingest queues of the compute core, and the overall workload score of the compute core is determined by the compute core based on a measurement, made by the compute core, of a length of a scheduling cycle of the compute core, the scheduling cycle being associated with execution of one or more polling tasks, and one or more additional tasks, wherein each additional task is selected out of a foreground task and a background task;
redirecting the access request to the destination compute core when the destination compute core differs from the given compute core; and
responding to the access request by the destination compute core, wherein the responding comprise accessing one or more storage nodes of the storage system and outputting an access response.

2. The method according to claim 1, comprising determining, by each compute core of the multiple compute cores, the foreground workload score of the compute core based on the statuses of ingest queues of the compute core.

3. The method according to claim 2, comprising determining, by each compute core of the multiple compute cores, the overall workload score of the compute core based on the measurement, made by the compute core, of the length of the scheduling cycle of the compute core.

4. The method according to claim 3, comprising measuring, by each compute core of the multiple compute cores, the length of the scheduling cycle of the compute core.

5. The method according to claim 4, comprising writing, by each compute core of the multiple compute cores, the foreground workload score and the overall workload score of the compute core to a sharable database.

6. The method according to claim 5, wherein the sharable database is stored in a non-volatile memory unit.

7. The method according to claim 1, comprising determining, by a given compute core of the multiple compute cores, an overall workload score of the given compute core regardless of one or more overall workload scores of one or more other compute cores of the multiple compute cores.

8. The method according to claim 1, comprising determining, by a given compute core of the multiple compute cores, an overall workload score of the given compute core based on one or more workload scores of one or more other compute cores of the multiple compute cores.

9. The method according to claim 1, comprising determining, by a given compute core of the multiple compute cores, an overall workload score of the given compute core based on statistics of lengths of the scheduling cycle of the compute core during one or more time periods.

10. A non-transitory computer readable medium for managing load regarding to access requests, the non-transitory computer readable medium stores instructions executable by a processor for:
receiving an access request by a given compute core of multiple compute cores of a computer node of a group of computer nodes of a storage system;
determining, by the given compute core, a destination compute core of the multiple compute cores to respond to the access request based on foreground workload scores and overall workload scores associated with the multiple compute cores;
wherein the determining comprises accessing the foreground workload scores and overall workload scores associated with the multiple compute cores;
wherein for each compute core of the multiple compute cores, the foreground workload score of the compute core is determined by the compute core based on statuses of ingest queues of the compute core, and the overall workload score of the compute core is determined by the compute core based on a measurement, made by the compute core, of a length of a scheduling cycle of the compute core, the scheduling cycle being associated with execution of one or more polling tasks, and one or more additional tasks, wherein each additional task is selected out of a foreground task and a background task;
redirecting the access request to the destination compute core when the destination compute core differs from the given compute core; and
responding to the access request by the destination compute core, wherein the responding comprise accessing one or more storage nodes of the storage system and outputting an access response.

11. The non-transitory computer readable medium according to claim 10, that further stores instructions executable by the processor for determining, by each compute core of the multiple compute cores, the foreground workload score of the compute core based on the statuses of ingest queues of the compute core.

12. The non-transitory computer readable medium according to claim 11, that further stores instructions executable by the processor for determining, by each compute core of the multiple compute cores, the overall workload score of the compute core based on the measurement, made by the compute core, of the length of the scheduling cycle of the compute core.

13. The non-transitory computer readable medium according to claim 12, that further stores instructions executable by the processor for measuring, by each compute core of the multiple compute cores, the length of the scheduling cycle of the compute core.

14. The non-transitory computer readable medium according to claim 13, that further stores instructions executable by the processor for writing, by each compute core of the multiple compute cores, the foreground workload score and the overall workload score of the compute core to a sharable database.

15. The non-transitory computer readable medium according to claim 14, wherein the sharable database is stored in a non-volatile memory unit.

16. The non-transitory computer readable medium according to claim 10, that further stores instructions executable by the processor for determining, by a given compute core of the multiple compute cores, an overall workload score of the given compute core regardless of one or more overall workload scores of one or more other compute cores of the multiple compute cores.

17. The non-transitory computer readable medium according to claim 10, that further stores instructions executable by the processor for determining, by a given compute core of the multiple compute cores, an overall workload score of the given compute core based on one or more workload scores of one or more other compute cores of the multiple compute cores.

18. The non-transitory computer readable medium according to claim 1, that further stores instructions executable by the processor for determining, by a given compute core of the multiple compute cores, an overall workload score of the given compute core based on statistics of lengths of the scheduling cycle of the compute core during one or more time periods.
